(19) United States
(12) Patent Application Publication
(10) Pub. No.: US 2019/0013517 A1
(43) Pub. Date: Jan. 10, 2019

(54) LITHIUM ION SECONDARY BATTERY

(71) Applicant: Murata Manufacturing Co., Ltd., Nagaokakyo-shi (JP)

(72) Inventor: Yayoi Katsu, Nagaokakyo-shi (JP)

(21) Appl. No.: 16/128,647

(22) Filed: Sep. 12, 2018

Related U.S. Application Data
(63) Continuation of application No. PCT/JP2017/002731, filed on Jan. 26, 2017.

(30) Foreign Application Priority Data
May 26, 2016 (JP) 2016-105278

(51) Int. Cl. H01M 4/36; H01M 10/0525; H01M 4/485; H01M 4/587; H01M 2/06; H01M 4/48

(52) U.S. Cl. CPC H01M 4/366; H01M 10/0525; H01M 4/485; H01M 2004/027; H01M 2/06; H01M 4/483; H01M 4/587

(57) ABSTRACT

A lithium ion secondary battery that includes a positive electrode having a positive electrode mixture layer; a negative electrode having a negative electrode mixture layer containing graphite and a metal oxide on a surface of the graphite; and a nonaqueous electrolyte. The negative electrode mixture layer included in the negative electrode has a D/G ratio as determined by Raman spectrometry of 0.40 to 0.52.

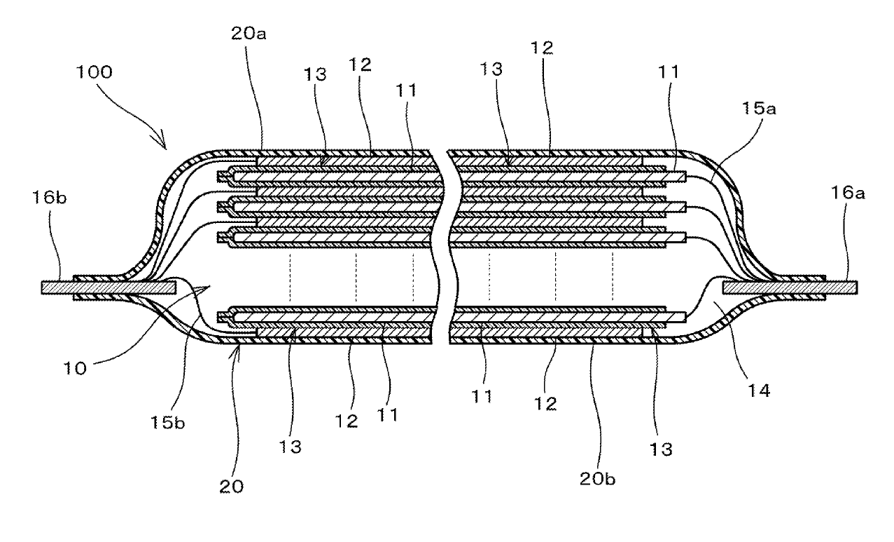

### CROSS REFERENCE TO RELATED APPLICATIONS

The present application is a continuation of International application No. PCT/JP2017/002731, filed Jan. 26, 2017, which claims priority to Japanese Patent Application No. 2016-105278, filed May 26, 2016, the entire contents of each of which are incorporated herein by reference.

### FIELD OF THE INVENTION

The present invention relates to a lithium ion secondary battery.

### BACKGROUND OF THE INVENTION

Lithium ion secondary batteries are widely used as portable electronic devices such as mobile phones and notebook computers, and batteries used in electric vehicles, hybrid vehicles, and the like. It is known that graphite is used as a negative electrode active material of this lithium ion secondary battery.

Since graphite has an extremely low operating potential of 0.5 V or less, when it is directly used as a negative electrode material, a nonaqueous electrolytic solution is decomposed. The decomposition of the nonaqueous electrolytic solution can be prevented by forming a passive-state film called “solid electrolyte interface (SEI)” on the surface of the lithium ion secondary battery at the initial charging. However, by doing so, the resistance of the interface between the nonaqueous electrolytic solution and the surface of the negative electrode is increased.

Meanwhile, metal oxides such as lithium titanate (Li₄Ti₅O₁₂) and titanium dioxide (TiO₂) have a high operating potential, and therefore, when these metal oxides are used as the negative electrode active materials, the SEI is not formed on the battery surface. Patent Documents 1 to 5 disclose a method of forming a lithium ion secondary battery using the above features, graphite as the negative electrode active material, and a negative electrode in which various metal oxides including the above-mentioned metal oxides present on the surface of the graphite.

Patent Document 1: Japanese Patent Application National Publication (Laid-Open) No. 2011-503782

Patent Document 2: Japanese Patent Application Laid-Open No. 2015-115319

Patent Document 3: Japanese Patent Application Laid-Open No. 2010-123283

Patent Document 4: Japanese Patent Application Laid-Open No. 2002-141069

Patent Document 5: Japanese Patent Application Laid-Open No. 2010-182477

### SUMMARY OF THE INVENTION

However, since the above-mentioned metal oxides have lower electron conductivity and lower lithium ion conductivity than graphite, there arises a problem that when the metal oxides are present on the surface of the graphite, the internal resistance is increased.

An object of the present invention is to provide a lithium ion secondary battery including a negative electrode having a negative electrode mixture layer containing a metal oxide on a surface of graphite, where the internal resistance is reduced.

The lithium ion secondary battery according to an aspect of the present invention includes a positive electrode having a positive electrode mixture layer; a negative electrode having a negative electrode mixture layer containing graphite and a metal oxide on a surface of the graphite; and a nonaqueous electrolyte. The negative electrode mixture layer has a D/G ratio as determined by Raman spectrometry of 0.40 to 0.52.

The metal oxide may be a titanium oxide.

Further, the titanium oxide may be either TiO₂ or Li₄Ti₅O₁₂.

According to the present invention, in a lithium ion secondary battery including a negative electrode having a negative electrode mixture layer containing graphite and a metal oxide on a surface of the graphite, the internal resistance can be reduced.

### BRIEF EXPLANATION OF THE DRAWING

The FIGURE is a cross-sectional view of a lithium ion secondary battery according to an embodiment of the present invention.

### DETAILED DESCRIPTION OF THE INVENTION

Hereinafter, the features of the present invention will be described in more detail with reference to embodiments of the present invention.

Hereinafter, a lithium ion secondary battery having a structure in which a stacked body formed by alternately stacking a plurality of positive electrodes and a plurality of negative electrodes with a separator interposed therebetween and a nonaqueous electrolyte are accommodated in an exterior body will be described as an example.

The FIGURE is a cross-sectional view of a lithium ion secondary battery 100 according to an embodiment of the present invention. The lithium ion secondary battery 100 has a structure in which a stacked body 10 formed by alternately stacking a plurality of positive electrodes 11 and a plurality of negative electrodes 12 with a separator 13 interposed therebetween and a nonaqueous electrolyte 14 are accommodated in a laminate case 20.

The laminate case 20, which is an exterior body, is formed by joining the peripheral portions of a pair of laminate films 20a and 20b by thermocompression bonding.

A positive electrode terminal 16a is led to the outside from one end side of the laminate case 20 and a negative electrode terminal 16b is led to the outside from the other end side. The plurality of positive electrodes 11 is connected to the positive electrode terminal 16a through lead wires 15a. Further, the plurality of negative electrodes 12 is connected to the negative electrode terminal 16b through lead wires 15b.

The negative electrode 12 has a negative electrode mixture layer containing graphite as a negative electrode active material and a metal oxide on the outer surface of the graphite. The negative electrode mixture layer has a D/G ratio as determined by Raman spectrometry of 0.40 to 0.52.

More specifically, the negative electrode 12 is formed by coating a negative electrode mixture layer on both surfaces of a negative electrode current collector made of a metal foil such as copper. The negative electrode mixture layer may further contain a conductive auxiliary agent and a binder.

As the metal oxide on the surface of the graphite, a titanium oxide is used, and for example, oxidized titanium (TiO₂) or lithium titanate (Li₄Ti₅O₁₂) is used. However, the metal oxide is not limited to the titanium oxide, and the titanium oxide is not limited to TiO₂, Li₄Ti₅O₁₂, or the like.

It is to be noted that there is no particular limitation on the material of the negative electrode current collector and the structure of the negative electrode mixture layer as long as the requirements “the negative electrode 12 has a negative electrode mixture layer containing graphite and a metal oxide on a surface of the graphite, and the negative electrode mixture layer has a D/G ratio as determined by Raman spectrometry of 0.40 to 0.52” are satisfied.

Here, when the D/G ratio of the negative electrode mixture layer determined by Raman spectrometry is larger than 0.52, the ratio of carbon having low crystallinity on the surface of the graphite is large, and thus it is difficult for the metal oxide to be attached to the surface of the graphite, and it is assumed that there is a possibility that the metal oxide is slipped into the nonaqueous electrolytic solution when contacted with the nonaqueous electrolytic solution. Considering that it is difficult for the metal oxide to be attached to the surface of the graphite, for example, when the amount of the metal oxide to be attached is increased, the internal resistance is increased, and thus it is assumed that there is a possibility to cause a problem that the diffusion of electrons and lithium ions does not proceed smoothly.

On the other hand, when the D/G ratio of the negative electrode mixture layer determined by Raman spectrometry is smaller than 0.40, except when the coating of the metal oxide to the graphite is performed very uniformly, the reaction between the graphite and the nonaqueous electrolytic solution promotes the formation of the SEI on the surface of the graphite, the interface resistance between the surface of the negative electrode and the nonaqueous electrolytic solution becomes large, and further the consumption of lithium ions progresses along with the formation of the SEI. Therefore, the cycle characteristics are considered to be deteriorated. Even when the coating of the metal oxide to the graphite is performed extremely uniformly, the negative electrode expands and shrinks due to charging and discharging of the battery, whereby the graphite is exposed on the surface and the formation of the SEI is promoted, and this may cause the above-mentioned problem.

Therefore, in the lithium ion secondary battery 100 according to the present embodiment, the negative electrode mixture layer is adjusted so as to have a D/G ratio as determined by Raman spectrometry of 0.40 to 0.52.

The positive electrode 11 has a positive electrode mixture layer. More specifically, the positive electrode 11 is formed by coating a positive electrode mixture layer on both surfaces of a positive electrode current collector made of a metal foil such as aluminum. The positive electrode mixture layer contains a positive electrode active material and may further contain a conductive auxiliary agent and a binder. It is to be noted that there is no particular limitation on the structure and material of the positive electrode 11.

As the separator 13, various separators usable for the lithium ion secondary battery can be used without particular limitation. Although the separator 13 shown in the FIGURE has a bag-shape, it may have a sheet-shape or may have a zigzag folded shape.

The nonaqueous electrolyte 14 may be any nonaqueous electrolyte as long as it can be used for the lithium ion secondary battery, and, for example, a known nonaqueous electrolytic solution can be used. As the nonaqueous electrolyte 14, a solid electrolyte may be used. It is to be noted that, in the case of using a polymer electrolyte having predetermined conditions as the solid electrolyte, a separator may be unnecessary in some cases.

In Examples 1 to 3 and Comparative Examples 1 to 5 described below, in order to confirm a difference in characteristics between the lithium ion battery satisfying the requirements of the present invention in that “the negative electrode 12 has a negative electrode mixture layer containing graphite and a metal oxide on a surface of the graphite, and the negative electrode mixture layer has a D/G ratio as determined by Raman spectrometry of 0.40 to 0.52” and the lithium ion battery not satisfying the requirements of the present invention, cells for evaluation were produced. The cells for evaluation in Examples 1 to 3 are cells satisfying the requirements of the present invention and the cells for evaluation in Comparative Examples 1 to 5 are cells not satisfying the requirements of the present invention.

### Example 1

In order to produce the negative electrode 12, a coating layer of oxidized titanium (TiO₂) was first formed on the surface of graphite having a D/G ratio as determined by Raman spectrometry of 0.47 using a powder barrel sputtering device. Then, graphite having a coating layer of oxidized titanium and polyvinylidene fluoride were mixed so that the weight ratio of the former to the latter was 92.5:7.5. The obtained mixture was dispersed in N-methyl-2-pyrrolidone to produce a negative electrode slurry.

The produced negative electrode slurry was coated on a copper foil having a thickness of 10 μm so as to be 2.75 mg/cm², dried at 120° C., and pressed so as to have a density of 1.3 g/cc, thereby producing a negative electrode sheet. At this time, the produced negative electrode sheet was subjected to Raman spectrometry and the D/G ratio (i.e., a peak area ratio of D and G bands) was calculated. In the Raman spectrometry, in order to analyze the surface of the sample, the D/G ratio of the negative electrode sheet is the same as the D/G ratio of the negative electrode mixture layer.

The formed negative electrode sheet was punched out to a diameter of 14 mm to produce an electrode for evaluation, and a coin cell including this electrode for evaluation was produced. Specifically, metallic lithium was used as a relative electrode of the electrode for evaluation, and an organic electrolytic solution obtained by dissolving 1 mol of lithium hexafluorophosphate (LiPF₆) per liter of solvent in a solvent of a mixture of ethylene carbonate (EC):ethyl methyl carbonate (EMC) at a weight ratio of 1:3 was used as the nonaqueous electrolyte 14. As the separator 13, a polyethylene porous membrane was used. The coin cell had a diameter of 20 mm and a thickness of 3.2 mm.

The produced coin cell was charged and discharged in a constant temperature oven at 25° C. three times in a voltage range of 0.01 to 2.0 V at a current value of 0.25 mA, and subsequently charged and discharged once in a voltage range of 0.01 to 2.0 V at a current value of 1 mA. Then, the ratio of the charge capacity when charging and discharging with a current value of 1 mA to the charge capacity when charging and discharging with a current value of 0.25 mA was calculated as the charge capacity maintenance ratio.

Thereafter, the SOC of the coin cell was adjusted to a predetermined value, two coin cells were disassembled in a glove box, and two electrodes for evaluation as negative electrodes were taken out. Then, a new coin cell was produced using the taken out two electrodes for evaluation, a newly prepared separator, and a newly prepared electrolytic solution. The coin cell was subjected to impedance measurement at a measurement frequency of 1.00 MHz to 50 mHz and a measurement voltage of ±10 mV in a constant temperature oven at 0° C.

Further, a coin cell was newly produced by the same production method as the coin cell produced for impedance measurement, and charging and discharging was repeated 30 times at a current value of 0.50 mA in a constant temperature oven at 25° C. Then, the charge capacity at the 30th cycle with respect to the charge capacity at the 1st cycle was calculated as the charge capacity maintenance ratio at 30 cycles.

### Example 2

In Example 2, in order to produce the negative electrode 12, a coating layer of lithium titanate (Li₄Ti₅O₁₂) was formed on the surface of graphite having a D/G ratio as determined by Raman spectrometry of 0.47 using a powder barrel sputtering device. Thereafter, a negative electrode sheet was produced by the same method as in Example 1, and a coin cell was produced.

In Example 2, the Raman spectrometry of the negative electrode sheet, the calculation of the charge capacity maintenance ratio, the impedance measurement, and the calculation of the charge capacity maintenance ratio at 30 cycles were performed in the same manner as in Example 1.

### Example 3

Graphite having a D/G ratio as determined by Raman spectrometry of 0.47 and an aqueous solution of titanium tetrachloride (TiCl₄) were placed in a beaker, an aqueous solution of sodium hydroxide (NaOH) was dropped to the mixture while stirring it, whereby oxidized titanium particles were precipitated on the surface of the graphite. Thereafter, the bath temperature of the mixture in the beaker was increased to 60° C. and the mixture was stirred for 24 hours, followed by filtration, washing, and drying, whereby oxidized titanium nanoparticles were supported on the surface of the graphite.

Thereafter, a negative electrode sheet was produced by the same method as in Example 1, and a coin cell was produced.

In Example 3, the Raman spectrometry of the negative electrode sheet, the calculation of the charge capacity maintenance ratio, the impedance measurement, and the calculation of the charge capacity maintenance ratio at 30 cycles were performed in the same manner as in Examples 1 and 2.

### Comparative Example 1

Graphite having a D/G ratio as determined by Raman spectrometry of 0.47 and polyvinylidene fluoride were mixed so that the weight ratio of the former to the latter was 92.5:7.5, and the obtained mixture was dispersed in N-methyl-2-pyrrolidone to produce a negative electrode slurry. Thereafter, a negative electrode sheet was produced by the same method as in Example 1, and a coin cell was produced. Namely, in the coin cell of Comparative Example 1, the used graphite had no metal oxide on the surface thereof.

In Comparative Example 1, the Raman spectrometry of the negative electrode sheet, the calculation of the charge capacity maintenance ratio, the impedance measurement, and the calculation of the charge capacity maintenance ratio at 30 cycles were performed in the same manner as in Examples 1 to 3.

### Comparative Example 2

Graphite having a D/G ratio as determined by Raman spectrometry of 0.89 and polyvinylidene fluoride were mixed so that the weight ratio of the former to the latter was 92.5:7.5, and the obtained mixture was dispersed in N-methyl-2-pyrrolidone to produce a negative electrode slurry. Thereafter, a negative electrode sheet was produced by the same method as in Example 1, and a coin cell was produced. In the coin cell of Comparative Example 2, the used graphite had no metal oxide on the surface thereof.

In Comparative Example 2, the Raman spectrometry of the negative electrode sheet, the calculation of the charge capacity maintenance ratio, the impedance measurement, and the calculation of the charge capacity maintenance ratio at 30 cycles were performed in the same manner as in Examples 1 to 3.

### Comparative Example 3

A coating layer of oxidized titanium (TiO₂) was formed on the surface of graphite having a D/G ratio as determined by Raman spectrometry of 0.89 using a powder barrel sputtering device. Thereafter, a negative electrode sheet was produced by the same method as in Example 1, and a coin cell was produced.

In Comparative Example 3, the Raman spectrometry of the negative electrode sheet, the calculation of the charge capacity maintenance ratio, the impedance measurement, and the calculation of the charge capacity maintenance ratio at 30 cycles were performed in the same manner as in Examples 1 to 3.

### Comparative Example 4

Graphite having a D/G ratio as determined by Raman spectrometry of 0.89 and an aqueous solution of titanium tetrachloride (TiCl₄) were placed in a beaker, an aqueous solution of sodium hydroxide (NaOH) was dropped to the mixture while stirring it, whereby oxidized titanium particles were precipitated on the surface of the graphite. Thereafter, the bath temperature of the mixture in the beaker was increased to 60° C. and the mixture was stirred for 24 hours, followed by filtration, washing, and drying, whereby oxidized titanium nanoparticles were supported on the surface of the graphite.

Thereafter, a negative electrode sheet was produced by the same method as in Example 1, and a coin cell was produced.

In Comparative Example 4, the Raman spectrometry of the negative electrode sheet, the calculation of the charge capacity maintenance ratio, the impedance measurement, and the calculation of the charge capacity maintenance ratio at 30 cycles were performed in the same manner as in Examples 1 to 3.

### Comparative Example 5

Graphite having a D/G ratio as determined by Raman spectrometry of 0.12 and polyvinylidene fluoride were mixed so that the weight ratio of the former to the latter was 92.5:7.5, and the obtained mixture was dispersed in N-methyl-2-pyrrolidone to produce a negative electrode slurry. Thereafter, a negative electrode sheet was produced by the same method as in Example 1, and a coin cell was produced. In Comparative Example 5, the used graphite had no metal oxide on the surface thereof.

In Comparative Example 5, the Raman spectrometry of the negative electrode sheet, the calculation of the charge capacity maintenance ratio, the impedance measurement, and the calculation of the charge capacity maintenance ratio at 30 cycles were performed in the same manner as in Examples 1 to 3.

[Evaluation of Characteristics]

The characteristics of the above-described Examples 1 to 3 and Comparative Examples 1 to 5 are shown in Table 1. Table 1 shows the D/G ratio of the graphite used for producing the negative electrode slurry, the type of metal oxide on the surface of the graphite, the D/G ratio of the negative electrode mixture layer, the charge capacity maintenance ratio (%), the absolute value |Z| of the impedance at a frequency of 0.5 Hz which is determined by impedance measurement at 0° C., and the charge capacity maintenance ratio at 30 cycles (%).

TABLE 1

| | | | | | | Charge |
|---|---|---|---|---|---|---|
| | | | D/G ratio of | Charge | | capacity |
| | | | the negative | capacity | Absolute | maintenance |
| | D/G ratio of | Metal | electrode | maintenance | value of | ratio at |
| | graphite | oxide | mixture layer | ratio (%) | impedance \|Z\| | 30 cycles (%) |
| Example 1 | 0.47 | TiO₂ | 0.52 | 73.7 | 173.5 | 63.3 |
| Example 2 | 0.47 | Li₄Ti₅O₁₂ | 0.52 | 69.8 | 151.0 | 65.1 |
| Example 3 | 0.47 | TiO₂ | 0.40 | 68.8 | 233.0 | 56.3 |
| Comparative | 0.47 | None | 0.42 | 74.7 | 267.5 | 71.2 |
| Example 1 | | | | | | |
| Comparative | 0.89 | None | 0.79 | 67.7 | 412.5 | 23.3 |
| Example 2 | | | | | | |
| Comparative | 0.89 | TiO₂ | 0.78 | 60.3 | 645.5 | 15.4 |
| Example 3 | | | | | | |
| Comparative | 0.89 | TiO₂ | 0.79 | 66.0 | 149.0 | 8.4 |
| Example 4 | | | | | | |
| Comparative | 0.12 | None | 0.11 | 65.0 | 495.6 | 10.2 |
| Example 5 | | | | | | |

As can be seen from comparison with the coin cell of Comparative Example 1 in which no metal oxide is present on the surface of the graphite constituting the negative electrode, the coin cell of Example 1 has a smaller absolute value |Z| of impedance at a frequency of 0.5 Hz, determined by impedance measurement at 0° C. Further, the absolute value |Z| of impedance is smaller than that of the coin cell of Comparative Example 3 in which, although the metal oxide is present on the surface of the graphite, the negative electrode mixture layer has a D/G ratio as determined by Raman spectrometry of 0.78, which is larger than 0.52. Hence, in the coin cell of Example 1 satisfying the requirements of the present invention, the internal resistance at a low temperature is small. Further, although not shown in Table 1, it was confirmed that the internal resistance was small even at room temperature.

Further, the coin cell of Example 1 showed a high charge capacity maintenance ratio of 73.7%, and the charge capacity maintenance ratio at 30 cycles was also as high as 63.3%. Hence, the coin cell of Example 1 satisfying the requirements of the present invention consequently exhibited good cycle characteristics.

The D/G ratio of the negative electrode mixture layer determined by Raman spectrometry in the coin cell of Example 2 is the same as that of the coin cell in Example 1, but the coin cells are different in the type of metal oxide present on the surface of the graphite constituting the negative electrode. It was found that the absolute value |Z| of the impedance and the internal resistance in the coin cell of Example 2 were smaller than those in the coin cell of Example 1. Further, it was found that the charge capacity maintenance ratio and the charge capacity maintenance ratio at 30 cycles showed high values, and the cycle characteristics were good.

The kind of metal oxide present on the surface of the graphite constituting the negative electrode in the coin cell of Example 3 is the same as that in the coin cell of Example 1, however, the coin cells are different in the D/G ratio of the negative electrode mixture layer as determined by Raman spectrometry because of using different methods of producing negative electrodes. It was found that the absolute value |Z| of the impedance and the internal resistance in the coin cell of Example 3 were smaller than those in the above-mentioned coin cells of Comparative Examples 1 and 3. Further, it was found that the charge capacity maintenance ratio and the charge capacity maintenance ratio at 30 cycles showed high values, and the cycle characteristics were good.

In the coin cell of Comparative Example 1, the D/G ratio of the negative electrode mixture layer as determined by Raman spectrometry is 0.42 and is within the range of 0.40 to 0.52, but no metal oxide is present on the surface of the graphite constituting the negative electrode. In the coin cell of Comparative Example 1, although the charge capacity maintenance ratio and the charge capacity maintenance ratio at 30 cycles showed high values, the absolute value |Z| of the impedance increased to 267.5. Hence, it was found that the internal resistance at a low temperature was high.

In the coin cell of Comparative Example 2, the metal oxide is not present on the surface of the graphite constituting the negative electrode and the D/G ratio of the negative electrode mixture layer as determined by Raman spectrometry is 0.79, which is larger than 0.52. In the coin cell of Comparative Example 2, although the charge capacity maintenance ratio was high, the absolute value |Z| of the impedance was as large as 412.5 and the charge capacity maintenance ratio at 30 cycles was as low as 23.3%. Hence, it is found that the resistance at a low temperature is high and the cycle characteristics are poor.

In the coin cell of Comparative Example 3, the metal oxide is present on the surface of the graphite constituting the negative electrode, but the D/G ratio of the negative electrode mixture layer as determined by Raman spectrometry is 0.78, which is larger than 0.52. In the coin cell of Comparative Example 3, the absolute value |Z| of the impedance is as large as 646.5 and the internal resistance is large. Further, the charge capacity maintenance ratio and the charge capacity maintenance ratio at 30 cycles are low as compared to those of the coin cells of Examples 1 to 3, and the cycle characteristics are inferior.

The coin cell of Comparative Example 4 differs from the coin cell of Comparative Example 3 in terms of using different methods of producing negative electrodes, and the D/G ratio of the negative electrode mixture layer as determined by Raman spectrometry is 0.79, which is larger than 0.52. In the coin cell of Comparative Example 4, although the absolute value |Z| of the impedance was small, the charge capacity maintenance ratio and the charge capacity maintenance ratio at 30 cycles were lower than those in the coin cells of Examples 1 to 3. Particularly, the charge capacity maintenance ratio at 30 cycles is 8.4%, and the cycle characteristics are poor.

In the coin cell of Comparative Example 5, the metal oxide is not present on the surface of the graphite constituting the negative electrode and the D/G ratio of the negative electrode mixture layer as determined by Raman spectrometry is 0.11, which is smaller than 0.40. In the coin cell of Comparative Example 5, the absolute value |Z| of the impedance is as large as 495.5 and the internal resistance is large. Further, it is found that the charge capacity maintenance ratio and the charge capacity maintenance ratio at 30 cycles are low as compared to those of the coin cells of Examples 1 to 3, particularly, the charge capacity maintenance ratio at 30 cycles is 10.2%, and the cycle characteristics are poor.

Hence, in the lithium ion secondary battery of the present embodiment satisfying the requirements “the negative electrode has a negative electrode mixture layer containing graphite and a metal oxide on a surface of the graphite, and the negative electrode mixture layer has a D/G ratio as determined by Raman spectrometry of 0.40 to 0.52”, the internal resistance is low even at a low temperature or room temperature. Further, the charge capacity maintenance ratio at 30 cycles is high, and the cycle characteristics are also excellent.

It was also confirmed that a titanium oxide, particularly TiO₂ or Li₄Ti₅O₁₂, was used as the metal oxide present on the surface of the graphite, whereby the internal resistance was lowered even at a low temperature or at room temperature. It is to be noted that even when titanium oxides other than TiO₂ or Li₄Ti₅O₁₂ are used, the internal resistance can be lowered.

In the above-described embodiment, a lithium ion secondary battery having a structure in which a stacked body formed by alternately stacking a plurality of positive electrodes and a plurality of negative electrodes with a separator interposed therebetween and a nonaqueous electrolyte are accommodated in an exterior body has been described as an example, however, the structure of the lithium ion secondary battery according to the present invention is not limited to the above structure. For example, the lithium ion secondary battery may have a structure in which a wound body formed by winding positive and negative electrodes stacked with a separator interposed therebetween and a nonaqueous electrolyte are accommodated in an exterior body. Further, the exterior body may be not a laminate case, but a metal can.

The present invention is not limited to the above embodiments in other respects, and various applications and modifications can be added within the scope of the present invention.

### DESCRIPTION OF REFERENCE SYMBOLS

10: Stacked body
11: Positive electrode
12: Negative electrode
13: Separator
14: Nonaqueous electrolyte
20: Laminate case
100: Lithium ion secondary battery

1. A lithium ion secondary battery comprising:
a positive electrode having a positive electrode mixture layer;
a negative electrode having a negative electrode mixture layer containing graphite and a metal oxide on a surface of the graphite; and
a nonaqueous electrolyte,
wherein the negative electrode mixture layer has a D/G ratio as determined by Raman spectrometry of 0.40 to 0.52.

2. The lithium ion secondary battery according to claim 1, wherein the metal oxide is a titanium oxide.

3. The lithium ion secondary battery according to claim 2, wherein the titanium oxide is TiO₂.

4. The lithium ion secondary battery according to claim 2, wherein the titanium oxide is Li₄Ti₅O₁₂.

5. The lithium ion secondary battery according to claim 1, further comprising a separator interposed between the positive electrode and the negative electrode.

6. The lithium ion secondary battery according to claim 1, wherein the D/G ratio is 0.47.

7. The lithium ion secondary battery according to claim 1, further comprising a case enclosing the positive electrode, the negative electrode and the nonaqueous electrolyte.

8. The lithium ion secondary battery according to claim 7, further comprising:
a positive electrode terminal extending outside of the case and electrically connected to the positive electrode; and
a negative electrode terminal extending outside of the case and electrically connected to the negative electrode.

9. A negative electrode comprising:
a negative electrode current collector; and
a negative electrode mixture layer on the negative electrode current collector, the negative electrode mixture layer containing graphite and a metal oxide on a surface of the graphite, and wherein the negative electrode mixture layer has a D/G ratio as determined by Raman spectrometry of 0.40 to 0.52.

10. The negative electrode according to claim 9, wherein the metal oxide is a titanium oxide.

11. The negative electrode according to claim 10, wherein the titanium oxide is TiO₂.

12. The negative electrode according to claim 10, wherein the titanium oxide is Li₄Ti₅O₁₂.

13. The negative electrode according to claim 1, wherein the D/G ratio is 0.47.
